(19) United States
(12) Patent Application Publication
(10) Pub. No.: US 2005/0208256 A1
(43) Pub. Date: Sep. 22, 2005

(54) Optical recording medium, method for producing the same, and optical recording and reproducing devices using the same

(75) Inventors: Hisae Yoshizawa, Ashigarakami-gun (JP); Jiro Minabe, Ashigarakami-gun (JP); Tatsuya Maruyama, Minato-ku (JP); Katsunori Kawano, Ashigarakami-gun (JP); Makoto Furuki, Ashigarakami-gun (JP); Hiroo Takizawa, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/938,580

(22) Filed: Sep. 13, 2004

(30) Foreign Application Priority Data
Mar. 22, 2004 (JP) 2004-83717

(51) Int. Cl. B32B 3/02

(52) U.S. Cl. 428/64.4

(57) ABSTRACT

An optical recording medium including an optically-active recording layer, wherein the recording layer includes a polymer microcrystalline phase.

### CROSS-REFERENCE TO RELATED APPLICATION

This application claims priority under 35 USC 119 from Japanese patent Application No. 2004-83717, the disclosure of which is incorporated by reference herein.

### BACKGROUND OF THE INVENTION

1. Field of the Invention

The present invention relates to an optical recording medium that is suitable for large capacity information recording by use of hologram recording and the like, a method for producing the same, and an optical recording and/or reproducing device using the same.

2. Description of the Related Art

Phase-change-type and magnetic-optical-type rewritable optical disk recording devices have been widely used. In the future, recording with higher capacity will be required because operating systems (OS) and application software are becoming increasingly sophisticated, multimedia documents and multimedia presentations are becoming common, and long-time video recording with higher definition and higher density will be required. However, these optical disk devices do not have sufficient performance to satisfy the requirements. In an existing high-density and large capacity optical disk recording device, the beam spot is made smaller to shorten a distance between adjacent tracks or adjacent bits in order to increase the recording density.

An example of products that have already been in practical use with such a technology is a DVD-ROM. A DVD-ROM has a diameter of 12 cm and can store data of 4.7 Gbyte (giga byte) on one side of a disk. A DVD-RAM, which is rewritable and erasable, has a diameter of 12 cm and utilizes phase change. A DVD-RAM can store date of as high as 5.2 Gbyte. The capacity of data that can be recorded on and read from a DVD-RAM is four times larger than that of a CD-ROM, and is as large as the total capacity of 1900 FLOPPY (R) DISKs. As recited above, recording density of optical disks has been becoming higher and higher. However, because the optical disk records data on a plane, capacity of data is limited by the diffraction limit of light. In other words, the recording density has come close to the physical limitation. In order to increase the capacity beyond the physical limitation, the three-dimensional (volume type) recording, which utilizes the thickness for recording, is required.

As a volume type optical recording medium, a medium composed of a photo refractive material capable of volume recording in a hologram grating is considered to be promising. Many researches have been conducted on optical refractive-index changing materials (hereinafter, sometimes abbreviated as a photorefractive material) and organic photorefractive materials are intensively studied because they are easy to process into arbitrary shapes and easy to control the responsive wavelength,.

A photorefractive material changes its refractive index in the following way: electric charges are generated by irradiation with light; the charges move and are trapped to make an internal electric field; the internal electric field causes the Pockels effect to change the refractive index. By the change of the refractive index, a hologram is formed. However, when the organic photorefractive material is used, an external electric field is necessary because molecules have to be oriented in order to make the Pockels effect work effectively. Accordingly, development of a photorefractive material that can be used without the external electric field is an important issue.

The hologram material that doesn't need the external electric field is, for example, an organic (particurlarly, polymer) photoisomerization material having an azobenzene skeleton as a photoisomerization group. The following documents can be referenced: Japanese Patent No. 2834470, Japanese Patent Application Laid-Open (JP-A) Nos. 2001-201634, 2000-105529, 2000-109719, 2000-264962 and 2001-294652. In hologram recording, a photoisomerization reaction of azobenzene plays an important role. When azopolymer is irradiated with a linearly polarized light, the azobenzene is reoriented through an isomerization cycle of trans-cis-trans. Owing to the reorientation, the optical anisotropy, i.e., the dichroism and birefringence, is induced. In this way, the hologram recording is achieved.

At the hologram recording, a hologram recording medium having such a configuration that a recording layer including a hologram recording material is provided on a support or a substrate is used from a viewpoint of convenience. In the hologram recording with a photoisomerization material, a recording layer is irradiated with light corresponding to recorded information, and a photoisomerization material included in the recording layer absorbs light to change its refractive index.

Various researches are actively carried out in order to obtain an optical recording medium with high sensitivity and high recording density including such photorefractive materials.

For example, S. Hvilsted proposes using a polymer having cyanoazobenzene on a side chain and writing a refractive index grating there to record a hologram (Opt. Lett., 17 [17], 12(1992)). The material using the polymer is expected to have a high recording density. For example, it is possible to write 2500 gratings of high and low refractive indexes within a breadth of 1 mm.

The inventors have conducted various studies on the polymer having azobenzene on a side chain and proposed using a polyester having azobenzene on a side chain which is useful as an optical recording material.

More specifically, monomers and polyesters having a methyl group introduced into the azobenzene were disclosed. Absorption bands of such monomers and polyesters were controlled in a region suitable for the optical recording. Optical recording media were also disclosed (For example, JP-A No. 2000-109719 can be referenced). Further, polyesters and an optical recording medium using the polyesters were disclosed (JP-A No. 2000-264962), wherein the polyesters have specific methylene groups on main chains and have controlled glass transition temperatures, in order to make the polyesters suitable for the optical recording. It was further disclosed (JP-A No. 2001-294652) that the optical recording characteristics are improved by using polyesters having specific methylene chains on side chains.

In order to obtain an optical recording medium with high sensitivity and high recording density, specific molecular structures of the optical recording material (photoresponsive material) are disclosed, for example in Opt. Lett., 17 [17], 12 (1992) and JP-A Nos. 2000-109719, 2000-264962, and 2001-294652. Apart from the molecular structures, the molecular weight of the material is also studied.

For example, it is known that when a molecular weight of an optical recording material is small, the sensitivity thereof tends to be high, and when the molecular weight is large, the stability of crystallinity/non-crystallinity of phases formed with the optical recording material is high (J. Physical. Chem., 100, 8836 (1996).

### SUMMARY OF THE INVENTION

Furthermore, in order to increase the capacity of a recording medium that includes a photoresponsive material such as the abovementioned photorefractive material in a recording layer, it is important to make a recording layer thicker. In addition, even when the recording layer is made thicker, the scattering has to be suppressed and the sensitivity has to be high. In other words, the optically induced anisotropy (birefringence) of the photoresponsive material in a photosensitive layer has to be large.

In general, the optically induced birefringence of a photoresponsive polymer material of an amorphous polymer system is relatively small and the record holding properties are poor. By contrast, a photoresponsive material of a crystal or liquid crystal polymer system has large optically induced birefringence, has thermal stability, and has excellent record holding properties.

In other words, a photoresponsive polymer material of a crystal or liquid crystal polymer system is suitable for improving sensitivity, that is, the crystal or liquid crystal polymer has high potential. Accordingly, in order to increase the capacity, it is preferable to provide a recording medium having a thick recording layer which includes a photoresponsive polymer material of a crystalline or liquid crystalline polymer system.

However, by an intensive study conducted by the inventors, it was found that a photoresponsive polymer material of a crystalline or liquid crystalline polymer system has a problem that, when the material forms a matrix as a recording layer, the material tends to form a large crystalline phase to increase scattering and the sensitivity decreases substantially. Furthermore, it was also found that suppression/control of a crystalline phase is difficult.

The present invention was made in consideration of the problems mentioned above.

A first aspect of the invention is to provide an optical recording medium comprising an optically-active recording layer, wherein the recording layer includes a polymer microcrystalline phase.

A second aspect of the invention is to provide a method of producing an optical recording medium comprising an optically-active recording layer made of recording layer materials including a polymer having a melting point Tm and a glass transition point Tg, the method comprising:

heating the recording layer materials to the melting point Tm or higher; and

cooling the recording layer materials at a cooling rate of 2° C./min or higher to form the recording layer,

wherein a recording layer after the cooling comprises a polymer microcrystalline phase having an average diameter in a range of 5 to 150 nm.

A third aspect of the invention is to provide an optical recording/reproducing device that records and/or reproduces information by using an optical recording medium including an optically-active recording layer,

wherein the recording layer comprises a polymer microcrystalline phase having an average diameter in a range of 5 to 150 nm.

### BRIEF DESCRIPTION OF THE DRAWINGS

FIG. 1 is a schematic view showing an example of an optical recording and reproducing device according to the present invention.

FIG. 2 is a schematic view showing the optical system that was used in evaluation of optical recording media.

FIG. 3 is a TEM image of the recording layer of the optical recording medium in Example 1.

FIG. 4 is a TEM image of the recording layer of the optical recording medium in Example 2.

### DESCRIPTION OF THE PRESENT INVENTION

An embodiment of the present invention is to provide an optical recording medium comprising an optically-active recording layer, wherein the recording layer includes a polymer microcrystalline phase.

The average diameter of the polymer microcrystalline phase may be in the range of 5 to 150 nm.

The average diameter of the polymer microcrystalline phase may be in the range of 5 to 70 nm.

The area proportion of the polymer microcrystalline phase in the recording layer may be 0.1% or higher.

The recording layer may include a photosresponsive polymer.

The recording layer may include a non-photoresponsive polymer.

When the recording layer includes a photoresponsive polymer, the polymer microcrystalline phase may include the photoresponsive polymer.

When the recording layer includes a non-photoresponsive polymer, the polymer microcrystalline phase may include the non-photoresponsive polymer.

When the recording layer includes a photoresponsive polymer, the photoresponsive polymer may have a melting point Tm and a glass transition point Tg, and a ratio of a weight average molecular weight Mw to a number average molecular weight Mn (Mw/Mn) may be 1.05 or higher.

The number average molecular weight Mn of the photoresponsive polymer may be in the range of 5,000 to 100,000.

The difference between the melting point Tm and the glass transition point Tg may be 60° C. or smaller.

The glass transition point Tg may be 35° C. or higher.

The number molecular-weight distribution of the photoresponsive polymer may have two or more maxima.

The difference between the molecular weights at any two maximum values among the two or more maximum values may be 5,000 or larger.

When the recording layer further includes a photoresponsive polymer, the photoresponsive polymer may have an azo group.

When the recording layer further includes a photoresponsive polymer, a content of the photoresponsive polymer in the recording layer may be in the range of 1.0 to 100 weight %.

An optical recording medium may include a substrate and the recording layer may be provided on the substrate.

A reflective layer may be further provided between the substrate and the recording layer.

Another embodiment according to the invention is to provide a method of producing an optical recording medium comprising an optically-active recording layer made of recording layer materials including a polymer having a melting point Tm and a glass transition point Tg, the method comprising:

heating the recording layer materials to the melting point Tm or higher; and

cooling the recording layer materials at a cooling rate of 2° C./min or higher to form the recording layer, wherein a recording layer after the cooling comprises a polymer microcrystalline phase having an average diameter in a range of 5 to 150 nm.

Still another embodiment according to the invention is to provide an optical recording/reproducing device that records and/or reproduces information by using an optical recording medium including an optically-active recording layer,

wherein the recording layer comprises a polymer microcrystalline phase having an average diameter in a range of 5 to 150 nm.

<Optical Recording Medium>

An optical recording medium according to the invention is an optical recording medium that comprises a recording layer including a photoresponsive polymer, wherein the recording layer includes a polymer microcrystalline phase. The term, “a polymer microcrystalline phase” used herein refers to a crystalline phase including a polymer whose diameter is approximately 300 nm or less.

The optical recording medium according to the invention includes a crystalline phase that, as mentioned above, scatters light and can cause a decrease in the sensitivity. However, the crystalline phase is a microcrystalline phase that has such an small average particle diameter as to be incapable of causing scattering of a light of a wavelength that is used in the recording and reproducing. On the other hand, a crystalline phase in the recording layer has an ability to improve sensitivity regardless of its size. If there is no counter-effect caused by scattering of light, the crystalline phase can certainly contribute to an improvement in sensitivity. In order to secure the effect of improving sensitivity, the average diameter of the polymer microcrystalline phase is preferably in the range of 5 to 150 nm.

Furthermore, the average diameter of the polymer microcrystalline phase is preferably in the range of 5 to 70 nm. If the average diameter is within such a range, crystals are more likely to be affected by vibration of the photoresponsive polymer caused by light and more likely to contribute to an improvement in sensitivity.

Accordingly, even though the recording layer includes a crystalline phase, the optical recording medium according to the invention can obtain a higher sensitivity in recording and reproducing information than an optical recording medium whose recording layer includes only an amorphous phase or a conventional optical recording medum whose recording layer includes a relatively large crystalline phase.

A higher proportion of the polymer microcrystalline phase is preferred. Specifically, an area proportion of the polymer microcrystalline phase in the recording layer is preferably 0.1% or higher. If the area proportion of the polymer microcrystalline phase is less than 0.1%, sufficient sensitivity cannot be obtained in some cases. Further, the phases other than the polymer microcrystalline phase are preferably amorphous phases which do not cause the scattering.

The average diameter of the polymer microcrystalline phase and the area proportion thereof can be obtained by an observation under a transmission electron microscope (TEM). Specifically, a specimen is embedded in a resin and dyed with OsO₄. At this time, the specimen becomes soft and deforms. Then, an ultrathin section of the dyed specimen is prepared with a cryo and dyed with RuO₄, followed by an observation with a TEM. The amorphous phase of the specimen, being dyed with metal, appears black in a TEM photograph, and a crystalline phase appears white. By subjecting thus obtained TEM photographs to image analysis, an area ratio of the white part to the whole area (the black part and the white part) can be obtained. Furthermore, 20 or more pieces of the white part are randomly sampled to measure the diameter thereof, and thereby an average diameter of a polymer microcrystalline phase is obtained.

Furthermore, the polymer microcrystalline phase may have an optical activity or may not have an optical activity. However, in the latter case, a phase other than the polymer microcrystalline phase has to have an optical activity. If the polymer microcrystal includes a photoresponsive polymer, it is obvious that the crystalline part is affected by a movement of the photoresponsive polymer and increase the sensitivity when the phase is irradiated with light.

If a non-photoresponsive polymer is mixed with a photoresponsive polymer which is miscible with the non-photosensitive polymer and the non-photosensitive polymer crystallizes to form a polymer microcrystalline phase, it is thought that the non-photoresponsive polymer in the polymer microcrystalline phase is affected by a movement of the photoresponsive polymer neighboring the non-photoresponsive polymer, resulting in an increase in the sensitivity.

-Photorepsonsive Material-

In the invention, at least one kind of photoresponsive polymer is included in a recording layer, and the photoresponsive polymer imparts an optical activity to the recording layer.

The term “a photoresponsibility (or an optical activity)” used herein refers to such properties that at least one change selected from a change in absorption coefficient, a change in refractive index, and a change in shape is caused by an irradiation with light. The term “a photoresponsive polymer” used herein refers to such a polymer that by irradiation of a matrix including the polymer, the polymer absorbs light and regions of the matrix irradiated with light make at least one change selected from a change in absorption coefficient, a change in refractive index, and a change in shape.

Here, the photoresponsive polymer used in the invention is preferably capable of causing a change in the absorption coefficient of the matrix and/or a change in the refractive index of the matrix.

-Photoresponsive Polymer-

In the following, the photorespoinsive polymer used in the optical recording medium according to the invention is described in more detail.

If the photoresponsive polymer used in the invention forms a polymer microcrystalline phase, the polymer itself has to have a certain level of crystallinity (or liquid crystallinity), and preferably has a melting point and a glass transition point, which are thermal physical property values.

Further, if an amorphous phase is formed as a phase other than the polymer microcrystalline phase, it is possible to use a polymer that has a glass transition point, or both a melting point and a glass transition point, each of which is a thermal physical property value.

In the following, the preferable photoresponsive polymer that has a melting point (Tm) and a glass transition point (Tg), which is preferable for the formation of a polymer microcrystalline phase, is described in more detail.

If a photoresponsive polymer has a melting point (Tm) and a glass transition point (Tg), the polymer is sometimes referred to as “a quasi-crystalline photoresponsive polymer” hereinafter. If a photosensitive polymer has a glass transition point (Tg) but does not have a melting point (Tm), the polymer is sometimes referred to as “an amorphous photoresponsive polymer” hereinafter. The quasi-crystalline photoresponsive polymer can exist in a crystalline state or an amorphous state. The crystallinity/amorphous properties can be controlled by controlling conditions of cooling the polymer in a molten state.

Because of these properties, it is possible to avoid formation of a big crystalline phase that causes scattering and it is easy to control formation of a polymer microcrystalline phase and an average diameter thereof. In addition to the formation of a polymer microcrystalline phase, it is also easy to form a stable amorphous phase.

A quasi-crystalline photoresponsive polymer has a ratio of a weight average molecular weight Mw to a number average molecular weight Mn (Mw/Mn) of preferably 1.05 or higher.

When an optical recording medium including such photoresponsive polymer is prepared, formation of a big crystalline phase can be easily suppressed and the scattering caused by a big crystalline phase can be prevented; therefore an optical recording medium with a high sensitivity can be obtained.

Further, a quasi-crystalline photoresponsive polymer has a ratio of the weight average molecular weight Mw to the number average molecular weight Mn (Mw/Mn) of preferably 1.05 or higher, more preferably of 1.2 or higher, and most preferably of 1.5 or higher.

If Mw/Mn is lower than 1.05, which means a molecular weight distribution is narrow, the photoresponsive polymer easily crystallizes to form a large crystalline phase when an optical recording medium including the photoresponsive polymer is produced. Accordingly, the scattering owing to the big crystalline phase occurs, resulting in a decrease in sensitivity in some cases.

The number average molecular weight Mn of a quasi-crystalline photoresponsive polymer is preferably in the range of 5,000 to 100,000, and more preferably in the range of 10,000 to 50,000.

If the number average molecular weight Mn is smaller than 5,000, the quasi-crystalline photoresponsive polymer easily crystallizes and forms a big crystalline phase when an optical recording medium including the quasi-crystalline photoresponsive polymer is produced.

On the other hand, if the number average molecular weight Mn is larger than 100,000, handling of the quasi-crystalline photoresponsive polymer is difficult during production of the optical recording medium.

When an optical recording medium is produced which has a recording layer including a quasi-crystalline photoresponsive polymer as a main component (its content in the recording layer is at least 10 weight %), the recording layer is formed by processes comprising: heating recording layer materials including the quasi-crystalline photoresponsive polymer heated to the melting point (Tm) of the quasi-crystalline photoresponsive polymer or higher; and cooling the recording layer materials. The method for producing an optical recording medium will be described in more detail later.

During the processes, if the recording layer materials are cooled relatively slowly, crystallization of the photoresponsive polymer could be accelerated in a temperature range between the melting point Tm and the glass transition point Tg, to develop a big crystalline phase.

Accordingly, the difference between the melting point Tm and the glass transition point Tg of the quasi-crystalline photoresponsive polymer is preferably 60° C. or less, and more preferably, 15° C. or less. If the value of Tm-Tg is larger than 60° C., a big crystalline phase could be formed owing to acceleration of the crystallization during the cooling. In this case, the sensitivity could be lowered owing to the scattering caused by the big crystalline phase.

The glass transition point Tg is preferably 35° C. or higher, and more preferably, 50° C. or higher. If the glass transition point Tg is lower than 35° C., recorded-information retention property of an optical recording medium including the quasi-crystalline photoresponsive polymer could be unstable to heat. As a result, when the optical recording medium is left under a hot environment, recorded information could be lost or deteriorated.

Though there is no particular upper limit of the glass transition point Tg, it is preferably 150° C. or lower in terms of workability during the production of the optical recording medium.

Preferably, the quasi-crystalline photoresponsive polymer has a value of Mw/Mn of 1.05 or higher. Such a high Mw/Mn ratio refers to a wide molecular weight distribution. Further, it is preferable for the number molecular-weight distribution to have two or more maxima.

If the number molecular-weight distribution has two or more maxima, photoresponsive polymers can contribute to an improvement in sensitivity if the polymers have a molecular weight close to a smaller molecular weight among the molecular weights that provide the maxima; and quasi-crystalline photoresponsive polymers can contribute to an increase in stability of a matrix (the inhibition of growth of a big crystalline phase) made of recording layer materials including the polymers if the polymers have a molecular weight close to a larger molecular weight among the molecular weights that provide the maxima.

Accordingly, the sensitivity of an optical recording medium could be higher which includes quasi-crystalline photoresponsive polymers having such a number molecular-weight distribution.

When the number molecular-weight distribution has two or more maxima, the largest difference between molecular weights that provide two maxima is preferably 5,000 or larger, and more preferably, 10,000 or larger. When the largest difference is smaller than 5,000, the sensitivity is not significantly higher than the sensitivity obtained in the case where the number molecular-weight distribution has substantially only one maximum.

In the invention, the melting point Tm and the glass transition point Tg of a quasi-crystalline photoresponsive polymer can be evaluated by a differential scanning calorimeter (trade name: DSC-50, manufactured by Shimadzu Corporation). At the measurement, firstly, a measurement sample is heated to a temperature which is 50° C. higher than the melting point of the polymer at a temperature rise rate of 1° C./min, and then the sample is cooled to a temperature which is approximately 20° C. lower than the glass transition point of the polymer at a temperature lowering rate of 10° C./min with liquid nitrogen. Subsequently, the sample is heated again at a temperature rise rate of 1.0° C./min. From the obtained relationship between the endothermic/exothermic change and temperature during the reheating process, a formal melting point Tm and a glass transition point Tg are measured.

Further, the number average molecular weight Mn, the weight average molecular weight Mw, and the number molecular-weight distribution of a quasi-crystalline photoresponsive polymer can be measured with a measuring device WATER liquid chromatograph 2695 (manufactured by Water Corp.), a column TSK Gel G40000HHR and G2000HHR (manufactured by Water Corp.), THF (tetrahydrofuran) as a solvent, and a differential refractometer as a detector (trade name: RI, manufactured by Water Corp.). The obtained value can be expressed as a polystyrene-equivalent value.

In the next place, a polymer material that can be used as a photoresponsive polymer is described in detail.

If a photoresponsive polymer is capable of causing a change in refractive index when irradiated with light, the polymer preferably includes an azo group. The azo group is preferably a part of an azobenzene structure (a structure in which benzene rings are provided on both ends of the azo group). When irradiated with light, irradiated areas of a matrix including the photoresponsive polymer change their refractive indexes through cis-trans isomerization of the azo group.

Further, if a photoresponsive polymer includes an azo group that is a part of an azobenzene skeleton, the azo group is included preferably on a side chain as a photoisomerization group (the photoisomerization group means a group that shows an isomerization reaction when irradiated with light).

Because the main chain and side chains of such a polymer material can be separately designed, it is possible to provide wide variety of polymers. Accordingly, it is easy to precisely control various physical properties such as sensitivity, absorption coefficient, responsive wavelength region, response rate, and record holding properties. For example, if a liquid crystalline linear mesogen group such as a biphenyl derivative is introduced onto a side chain in addition to the photoisomerization group, change in orientation of the photoisomerization group caused by irradiation with light can be accelerated and fixed, resulting in suppression of absorption loss.

Further, it can be easily controlled whether or not a photoresponsive polymer has a melting point or a glass transition point or both by controlling the constitutional proportion(s) of crystalline constitutional units and/or amorphous constitutional units included in the photoresponsive polymer. In other words, it can be easily controlled whether the photoresponsive polymer is quasi-crystalline or whether the photoresponsive polymer is amorphous.

The term “a crystalline constitutional unit” used herein refers to such a constitutional unit that a polymer consisting of a repetition of the unit is crystalline (or liquid crystalline) and has both a melting point and a glass transition point. The term “an amorphous constitutional unit” used herein refers to such a constitutional unit that a polymer consisting of the unit is amorphous (non-crystalline) and has a glass transition point but does not have a melting point.

In the invention, the term “quasi-crystalline photoresponsive polymer” used herein refers to a photoresponsive polymer consisting of crystalline constitutional units or a photoresponsive polymer comprising crystalline constitutional units as main components. The term “an amorphous photoresponsive polymer” used herein refers to a photoresponsive polymer consisting of amorphous constitutional units or a photoresponsive polymer comprising amorphous constitutional units as main components.

The quasi-crystalline photoresponsive polymer can form a crystalline phase or an amorphous phase depending on the cooling condition. If a quasi-crystalline photoresponsive polymer forms a crystalline phase, it is possible to control the average diameter of the crystal in the range of 5 to 150 nm.

Repeating constitutional units in a quasi-crystalline photoresponsive polymer preferably include both of crystalline constitutional units and amorphous constitutional units. In this case, the proportion of the crystalline constitutional units in the total constitutional units is in the range of preferably 20 to 99 mol %. When the proportion is 20 mol % or lower, the sensitivity tends to be low, and when it is 99 mol % or higher, a big crystalline phase is likely to be formed and scattering could occur.

The photoresponsive polymer described above can be prepared by a known polymer synthesis method. For example, if a quasi-crystalline photoresponsive polymer includes crystalline constitutional units and amorphous constitutional units at a predetermined ratio, the polymer can be easily prepared by copolymerizing monomers corresponding to the crystalline constitutional units, monomers corresponding to the amorphous constitutional units, and monomers having photoisomerization groups on side chains. A photoresponsive polymer can be obtained which has desired physical properties such as Tg, Tm, Mn, Mw, and number molecular-weight distribution by this process with suitable selection of the copolymerization ratios of respective monomers, the polymerization degree, the structures of respective monomers, and the like.

Photoresponsive polymers including constitutional structures represented by the following formulae (1), (2), (3), and (4) are examples of the photoresponsive polymers according to the invention.

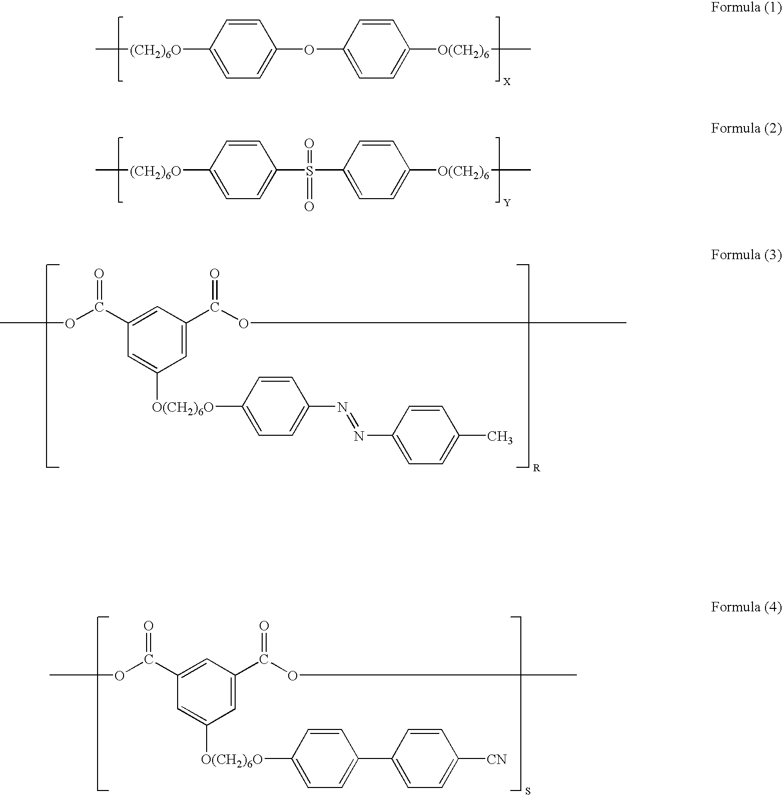

The constitutional unit shown in the formula (1) is a crystalline constitutional unit, the constitutional unit shown in the formula (2) is an amorphous constitutional unit, the constitutional unit shown in the formula (3) is a constitutional unit including an azo group on a side chain as a photoisomerization group, and the constitutional unit shown in the formula (4) is a constitutional unit having a linear mesogen group including a biphenyl derivative on a side chain for the purpose of strengthening and fixing a change in the orientation of a photoisomerization group.

By controlling constitutional ratios of the constitutional units of the formulae (1) to (4) (ratios among X, Y, R, and S), a photoresponsive polymer having desired properties can be obtained. For example, when a photoresponsive polymer has the following molar ratio of the constitutional units: constitutional units of the formula (1): constitutional units of the formula (2): constitutional units of the formula (3): constitutional units of the formula (4)=X:Y:R:S=0.6 to 0.9:0.1 to 0.4:0.1 to 0.9:0.1 to 0.9, the polymer is a quasi-crystalline photoresponsive polymer having a melting point and a glass transition point; by using this polymer in preparing a recording layer, it is possible to form a polymer microcrystalline phase having an average diameter of 10 nm or smaller.

-Constitution of Optical Recording Medium and Method For Producing the Medium-

In the following, the constitution of an optical recording medium according to the invention is described in detail. An optical recording medium according to the invention includes a recording layer having an optical activity, and the recording layer is provided preferably on a substrate (or a support). A reflective layer can be provided between the recording layer and the substrate. A protective layer for protecting the recording layer can be provided on the side of the recording layer opposite to the substrate. The protective layer may be a substrate, which refers to a constitution having a recording layer sandwiched between substrates. Further, an intermediate layer can be provided properly in order to secure the adhesiveness or the like between a substrate and a reflective layer or a recording layer or between any two of a reflective layer, a recording layer and a protective layer, in accordance with necessity.

There is no particular restriction on a shape of the optical recording medium. As far as the recording layer is in flat shape with a constant thickness, any forms can be selected such as a disk shape, a sheet shape, a tape shape, and a drum shape.

Optical recording media in the conventional disk-shape having a hole at the center are compatible with existing production methods of optical recording media and recording/reproducing system. The optical recording medium according to the invention preferably has such a shape.

(Substrate/Support)

As the substrate and the support, various kinds of materials with a smooth surface can be selected and used. For example, metals, ceramics, resins and paper can be used. Further, there is no particular restriction on a shape thereof. Optical recording media in the conventional disk-shape having a hole at the center are compatible with existing production methods of optical recording media and recording/reproducing system. The substrate according to the invention preferably has such a shape.

Specific examples of the substrate material include glass; acrylic resins such as polycarbonate and polymethylmethacrylate; vinyl chloride resins such as polyvinyl chloride and vinyl chloride copolymer; an epoxy resin; amorphous polyolefin; polyester; metals such as aluminum. If desired, plural kinds of materials can be used in combination.

Among the materials mentioned above, amorphous polyolefin and polycarbonate are preferable, and polycarbonate is particularly preferable, from a viewpoint of the moisture resistance, the dimensional stability and the low price.

Further, a guide groove for tracking or concavity and convexity (pre-groove) representing information such as an address signal may be formed on a surface of the substrate.

If light used in recording and reproducing has to go through the substrate before reaching the recording layer, the substrate materials may be materials that transmit the light used (recording light and reproducing light). In this case, the transmittance of the material is preferably 90% or higher in the wavelength region of the light used (in the case of laser, around the wavelength region where the intensity is maximum).

When a reflective layer is provided on a surface of the substrate, an undercoat layer is preferably formed in order to improve the planarity and to increase the adhesive force.

Examples of the materials of the undercoat layer include polymers such as polymethylmethacrylate, acrylate-methacrylate copolymers, styrene-(maleic anhydride) copolymers, polyvinyl alcohol, N-methylol acrylamide, styrene-vinyltoluene copolymers, chlorosulfonated polyethylene, cellulose nitrate, polyvinyl chloride, chlorinated polyolefins, polyesters, polyimides, (vinyl acetate)-(vinyl chloride) copolymers, ethylene-(vinyl acetate) copolymers, polyethylene, polypropylene, polycarbonate; and the surface modifier such as silane coupling agents.

The undercoat layer can be formed by: preparing a coating liquid by dissolving or dispersing a material mentioned above in an adequate solvent; coating a surface of a substrate with the coating liquid by a method such as a spin coating method, a dip coating method and an extrusion coating method. In general, the thickness of the undercoat layer is preferably in the range of 0.005 to 20 μm, and more preferably in the range of 0.01 to 10 μm.

(Reflective Layer)

The reflective layer is preferably made of a light reflective material whose reflectance to the laser light is 70% or higher. Examples of such a light reflective material include metals and semi-metals such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, Bi and stainless steel.

A single light reflective material may be used, or plural light reflective materials may be used in combination. Alloys of light reflective materials may also be used. Cr, Ni, Pt, Cu, Ag, Au, Al and stainless steel are preferable examples of the light reflective material. Au, Ag, Al or alloys thereof are particularly preferable, and Au, Ag and alloys thereof are the most preferable.

The reflective layer can be formed, for instance, by vapor-depositing, sputtering or ion plating the reflective materials on a substrate. In general, the thickness of the reflective layer is preferably in the range of 10 to 300 nm, and more preferably, in the range of 50 to 200 nm.

(Protective Layer)

A protective layer can be made of any known materials as long as the protective layer having a suitable thickness can protect the recording layer mechanically, physically and chemically under an ordinary environment in which the optical recording medium is used. For instance, in general, a transparent resin and a transparent inorganic material such as SiO₂ can be cited.

If recording or reproducing light has to go through a protective layer before reaching the recording layer, materials that transmit the light may be used to prepare the protective layer. In this case, the transmittance of the protective layer is preferably 90% or higher within the wavelength region of the light used (in the case of laser, around the wavelength region where the intensity is maximum). If recording or reproducing light has to go through an intermediate layer before reaching the recording layer, materials that transmit the light may be used to prepare the intermediate layer. In this case, the transmittance of the intermediate layer is preferably 90% or higher within the wavelength region of the light used (in the case of laser, around the wavelength region where the intensity is maximum).

A resin film which has been formed into a sheet can be used to form a resin protective layer. The resin film may be a polycarbonate film or a cellulose triacetate film. The resin protective layer can be formed by laminating the resin film on the recording layer. When the film is laminated on the recording layer, it is preferable to use a thermosetting or UV-curable adhesive between the film and the recording layer in order to secure the adhesive strength. The adhesive is then cured by heat or UV irradiation. There is no particular restriction on the thickness of the resin film used as the protective layer on condition that the protective layer can protect the recording layer. From a practical standpoint, the thickness is preferably in the range of 30 to 200 μm, and more preferably, in the range of 50 to 150 μm.

Alternatively, a thermoplastic resin, a thermosetting resin, or a photo-curable resin can be applied to form a protective layer instead of using such a resin film.

When a protective layer made of transparent ceramics such as SiO₂, MgF₂, SnO₂, and Si₃N₄, or a protective layer made of a glass material is prepared, the protective layer can be formed by a sputtering method or a Sol-Gel method. There is no particular restriction on the thickness of the transparent inorganic material on condition that the protective layer can protect the recording layer. From a practical standpoint, the thickness is preferably in the range of 0.1 to 100 μm, and more preferably, in the range of 1 to 20 μm.

(Recording Layer)

The thickness of the recording layer is not particularly restricted and can be an arbitrary thickness. However, from a practical standpoint, the thickness is preferably in the range of 1 μm to 5 mm. The type of an optical recording medium is determined by the relationship between the distance between adjacent interference bands recorded on the recording layer and the thickness of the recording layer. More preferable thickness range of the recording layer of each type is described in the following.

When an optical recording medium is a plane hologram (when the thickness of the recording layer is thinner than or equal to the distance between adjacent interference bands recorded on the recording layer), the thickness is preferably in the range of 1 to 100 μm, and more preferably in the range of 5 to 20 μm.

On the other hand, when an optical recording medium is a volume hologram (when the thickness of the recording layer is equal to or larger than the distance between adjacent interference bands recorded on the recording layer), the thickness is preferably in the range of 100 μm to 5 mm, and more preferably in the range of 250 μm to 1 mm.

The recording layer includes photoresponsive materials such as the photoresponsive polymers. A material in the recording layer is sometimes abbreviated as “a recording layer material” hereinafter. All the recording layer materials may be photoresponsive polymers. However, various kinds of materials (such as photoresponsive materials made of low-molecular weight molecules, photoresponsive materials made of inorganic materials, and non-photoresponsive materials) can be included in the recording layer materials.

In this case, the recording layer materials constituting the recording layer preferably includes at least a photoresponsive polymer, and a content thereof is preferably 5 weight % or higher, and more preferably 10 weight % or higher.

The recording layer materials may include one photoresponsive polymer or plural photoresponsive polymers. When only one photoresponsive polymer is included in the recording layer, the polymer is preferably a quasi-crystalline photoresponsive polymer.

When two or more photoresponsive polymers are used, the polymers preferably include an amorphous photoresponsive polymer and a quasi-crystalline photoresponsive polymer that forms a polymer microcrystalline.

When the recording layer materials include photoresponsive polymers and other materials, as the other material, a non-photoresponsive polymer can be used in accordance with necessity. In this case, the non-photoresponsive polymer can be included in a polymer microcrystalline phase.

There is no particular restriction on physical properties (such as existence or absence of a melting point, existence or absence of a glass transition point, values thereof, the weight average molecular weight, the number average molecular weight, and the ratio thereof) of the non-photoresponsive polymer. However, the non-photoresponsive polymer is preferably capable of forming a polymer microcrystalline phase with an average diameter of 5 to 150 nm in the recording layer

When a quasi-crystalline photoresponsive polymer is used in combination with a non-photoresponsive polymer, a blend polymer obtained by blending the quasi-crystalline photoresponsive polymer and the non-photoresponsive polymer preferably has both a melting point Tm′ and a glass transition point Tg′, the difference between the melting point Tm′ and the glass transition point Tg′ is preferably 60° C. or smaller, and the ratio Mw′/Mn′ is preferably 1.05 or higher.

Specific examples of the non-photoresponsive polymer include non-crystalline polymethyl methacrylate and polyphenylene ether, and polyethersulfone. Among the polymers, a polymer that satisfies the following conditions is preferable: the polymer is miscible with the quasi-crystalline photoresponsive polymer; when the polymer is blended with the quasi-crystalline photoresponsive polymer, the resultant blend polymer has a melting point Tm′ and a glass transition point Tg′ wherein the difference between Tm′ and Tg′ is 60° C. or smaller and the weight average molecular weight Mw′ and the number average molecular weight Mn′ of the blend polymer satisfy the relationship “Mw′/Mn′ is equal to or larger than 1.05”.

Furthermore, a crystalline polymer such as polyethylene terephthalate can be used as the non-photoresponsive polymer. In this case, the crystalline polymer is preferably miscible with the photoresponsive polymer that is to be blended. When the polymer is blended with the quasi-crystalline photoresponsive polymer, the resultant blend polymer preferably has a melting point Tm′ and a glass transition point Tg′ wherein the difference between Tm′ and Tg′ is preferably 60° C. or smaller and the weight average molecular weight Mw′ and the number average molecular weight Mn′ of the blend polymer preferably satisfy the relationship “Mw′/Mn′ is equal to or larger than 1.05”.

In the formation of a recording layer, a known method can be appropriately selected and used depending on the recording layer materials.

In the following, a method for producing an optical recording medium according to the invention is described in more detail, using a recording layer made of a quasi-crystalline photoresponsive polymer as an example. In this example, the recording layer of an optical recording medium according to the invention is preferably formed (or processed) by a method comprising the following two steps.

The first step is a heating step. In this step, the recording layer materials are heated to a temperature which is equal to or higher than the melting point Tm of the quasi-crystalline photoresponsive polymer. The second step is a cooling step. In the second step, the heated recording layer materials are cooled at a cooling rate of 2° C./min or higher.

The temperature region between the glass transition point Tg and the melting point Tm of the quasi-crystalline photoresponsive polymer plays a major role in determining which form (crystalline/amorphous) the polymer is going to take and which degree the crystallinity or amorphousness is going to be to. Consequently, if the cooling rate is satisfied at least within the temperature region, the preferable effects caused by the steps can be obtained.

If an optical recording medium is manufactured without undergoing such steps, even when a quasi-crystalline photoresponsive polymer is used, a big crystalline phase might be formed in a matrix constituting the recording layer and scattering might become remarkable. As a result, sufficient sensitivity cannot be obtained in some cases.

When optical recording media are mass-produced, owing to difference or variation in heat-treating history of the recording layers of the optical recording media, the form (crystallinity/amorphousness) and its extent could be unstable; accordingly, the variation in sensitivity is large in some cases.

In the heating step, it is necessary to heat the recording layer materials to a temperature which is equal to or higher than the melting point Tm of the quasi-crystalline photoresponsive polymer included in the materials. However, within the temperature region of no lower than the melting point Tm, step can be appropriately modified depending on which procedure (forming or processing the recording layer) the heating step is included and the composition of the recording layer.

For example, when recording layer materials are melted in order to form a recording layer, the materials are preferably heated to a temperature which is no lower than the temperature at which the materials melt sufficiently for forming a recording layer. In this case, this melting process can be regarded as the heating step.

In this case, for example, if the recording layer consists only of a quasi-crystalline photoresponsive polymer, the polymer may be heated to the melting point thereof Tm or higher. If the recording layer materials include quasi-crystalline photoresponsive polymers and other polymers, the temperature to which the materials are heated is appropriately determined so that the materials melt sufficiently for formation of the recording layer. The temperature can be determined, for example by considering the highest melting temperature among the melting temperatures of the materials or by considering the melting temperature of the material having the highest content.

Alternatively, an already-formed recording layer with a predetermined shape and film thickness can be heated to conduct the heating step.

On the other hand, the cooling step is carried out preferably at a cooling rate of 2° C./min or higher, and more preferably at the cooling rate of 5° C./min or higher.

If the cooling rate is lower than 2° C./min, crystallization of a quasi-crystalline photoresponsive polymer included in the recording layer materials could be accelerated to form a big crystalline phase, which causes scattering and decreases the sensitivity in some cases.

In the cooling step, if the recording layer is sufficiently thin or the heat capacity of a carrier such as a substrate or a holder on which the recording layer is held is so small that the heat dissipation property is excellent, the recording layer materials can be cooled naturally.

However, if the recording layer is thick or the heat capacity of a carrier such as the substrate or the holder whereon the recording layer is held is large, it is preferable to cool the recording layer materials forcibly by use of a known wind-cooling method or liquid-cooling method. The use of such forced cooling methods is preferable also because optical recording media with stable quality can be mass-produced regardless of environmental temperature and humidity.

During the production of optical recording media according to the invention, it is preferable not to conduct a heating treatment at a temperature which is close to or higher than the glass transition point Tg of the quasi-crystalline photoresponsive polymer after the heating and cooling steps are completed. If such a heating treatment is conducted after the heating and cooling steps are completed, the extent and state of the crystallinity/amorphousness of the recording layer that are once arranged are caused to change again by the heating treatment and a following cooling treatment; consequently, sufficient sensitivity cannot be obtained in some cases.

As a method of forming the recording layer, a known method can be used. For example, liquid phase film formation methods such as a spray method, a spin coat method, a dip method, a roll coat method, a blade coat method, a doctor roll method and a screen print method can be used which use a coating liquid in which the recording layer materials including the quasi-crystalline photoresponsive polymer are dissolved. A vapor-deposition method can also be used. In the case of the vapor-deposition method, the vapor-deposition can work also as the heating step.

However, the thickness of the recording layer formed by these methods is not sufficient for producing a volume hologram optical recording medium. In such a case, a plate-like recording layer is preferably formed by injection-molding and/or hot pressing recording layer materials whose main components are polymers. By such methods, a recording layer with a film thickness of 0.1 mm or more that is necessary for volume hologram optical recording media can be easily formed.

When an optical recording medium including such a plate-like recording layer, the recording layer may be sandwiched between two substrates; if the recording layer is thick and has sufficient rigidity and strength, it is possible to use the recording layer itself as an optical recording medium. The injection molding or the hot-press employed to form the plate-like recording layer may work also as the heating step.

In the next place, a method of producing optical recording media having the above-mentioned constitutions will be explained.

When an optical recording medium is a plane hologram, as is mentioned above, the medium can be prepared by sequentially laminating on a substrate layers such as a recording layer in accordance with materials used in respective layers.

An example is described below which is a sequence of main processes for production of an optical recording medium having a recording layer and a protective layer on a substrate. The sequence comprises: providing a coating liquid by dissolving photoresponsive polymers in a solvent; spin-coating a polycarbonate substrate with the coating liquid to form a recording layer with a predetermined shape and thickness; sufficiently drying the recording layer; heating the recording layer and the substrate to a temperature which is no lower than the melting point Tm of the quasi-crystalline photoresponsive polymer included in the recording layer while preventing the recording layer and the substrate from deforming; keeping the recording layer at the temperature for a while; and forcibly cooling the recording layer and the substrate by a Peltier type cooler at a cooling rate of 30° C./min or higher. If the polycarbonate substrate deforms or deteriorates at Tm of the quasi-crystalline photoresponsive polymer, it is preferable to substitute the polycarbonate substrate with a more heat-resistant substrate.

The sequence further comprises after the forced cooling: drying the surface of the recording layer; evenly spin-coating the recording layer with a UV-curable adhesive; laminating the recording layer and a cellulose triacetate resin film which is to work as a protective layer; and irradiating the laminate with a UV light to cure the adhesive. In this way, an optical recording medium having a constitution, a protective layer/a recording layer/a substrate, can be obtained.

If an optical recording medium is a volume hologram, as is mentioned above, a recording layer is formed by injection molding or hot pressing or both. Accordingly, an optical recording medium can be manufactured in the following way.

An optical recording medium can be produced by the following example process comprising an injection molding. The process comprises: providing a disk-like molded matter that is to be a recording layer by an injection molding; sandwiching the molded matter between two disk-like transparent substrates; and bonding the molded matter to the substrates by a hot press (hot melt adhesion).

In the injection molding, a resin as a raw material (a resin including at least a quasi-crystalline photoresponsive polymer) is heated and melted, and the molten resin is injected into a molding die to form a disk. The injection molding machine may be an in-line injection molding machine in which a function of plasticizing the raw material and a function of injecting are integrated, or an preplunger injection molding machine in which the plasticization function and the injection function are separated. As the conditions of injection molding, the injection pressure is preferably in the range of 1,000 to 3,000 Kg/cm², and the injection rate is preferably in the range of 5 to 30 mm/sec.

In the hot pressing, a thick plate-like molded matter obtained in the injection molding is sandwiched between two transparent disk-like substrates, and hot-pressed under vacuum.

The optical recording medium manufactured in this way is prepared not by forming a recording layer on a substrate but by forming a recording layer by injection molding separately from the substrate; accordingly, the recording layer can be easily made thicker and the medium is suitable for mass-production. Further, the recording layer has a sufficient sensitivity, which includes a quasi-crystalline photoresponsive polymer and has undergone the heating and cooling steps mentioned above. Still furthermore, even when the recording layer is thick, its recording characteristics are not damaged by influences of light absorption and scattering. This is because residual strain of the molded matter caused by the injection molding is equalized during the hot-pressing, in which the recording layer is bonded to the transparent substrates.

In this process, the heating step, in which the recording layer materials are heated to a temperature which is no lower than the melting point Tm of the quasi-crystalline photoresponsive polymer included in the recording layer, and the subsequent cooling step may be conducted when the injection molding or the hot pressing is conducted. In other words, the injection molding or the hot pressing may work as the heating step since the recording layer materials are heated in the injection molding and the hot pressing.

However, sometimes, it is not preferable to combine the heating and cooling steps with the injection molding since the hot pressing is conducted after the injection molding; the effects of the heating and cooling steps are sometimes lost when the recording layer materials are heated in the hot pressing or when the recording layer materials are cooled in inappropriate conditions after the hot pressing. In such a case, the heating and cooling steps are preferably combined with the hot pressing. Further, if it is difficult to combine the heating and cooling steps with the hot pressing because of the hot press device and the hot-pressing conditions, the heating and cooling steps can be conducted at any time after the completion of the hot pressing.

When the hot pressing is conducted, an optical recording medium can be produced by the following example process. The process comprising: sandwiching a powdery resin (a resin including a quasi-crystalline photoresponsive polymer) between substrates with high releasability such as a TEFLON (R) sheet (a press member); and hot-pressing the laminate in this state under vacuum to directly form a recording layer.

The hot pressing is preferably a vacuum hot pressing. When the vacuum hot pressing is conducted, a powdery resin (sample) is placed between two press members. Subsequently, the temperature of the press members is gradually raised to a predetermined temperature which is no lower than the melting point Tm of the resin at a reduced pressure of about 0.1 MPa in order to prevent generation of air bubbles and a pressure is applied to the press members to press the sample. The pressing pressure is preferably in the range of 0.01 to 0.1 t/cm². After hot pressing the sample for a predetermined time, the heating and the pressins are stopped, and the sample is taken out after cooled to room temperature.

When such a hot pressing is conducted, the resin material sandwiched between the press members is heated and melted, then cooled to form a plate-like recording layer. For example, if a recording layer is made of a quasi-crystalline azo polymer, the hot pressing can be conducted at about 70° C. to form a recording layer with a predetermined thickness since the melting point (Tm) of the azo polymer is as low as about 50° C. Further, the hot pressing does not cause residual strain.

A protective layer or the like may be provided in order to improve the scratch resistance and the moisture resistance of the optical recording medium, which is the recording layer.

Further, the heating and cooling steps can be conducted when the hot pressing is conducted. If it is difficult to combine the heating and cooling steps with the hot pressing because of the hot press device and the hot-pressing conditions, the heating and cooling steps can be conducted separately at any time after the completion of the hot pressing.

The optical recording medium produced in this way is prepared not by forming a recording layer on a substrate but by forming a recording layer by hot pressing separately from the substrate; accordingly, the recording layer can be easily made thicker. Further, the recording layer has a sufficient sensitivity, which includes a quasi-crystalline photoresponsive polymer and has undergone the heating and cooling steps. Still furthermore, even when the recording layer is thick, its recording characteristics are not damaged by influences of light absorption and scattering. This is because residual strain of the molded matter does not occur during the formation of the recording layer by hot press.

As is explained above, the optical recording medium according to the invention which is produced by undergoing the above mentioned process and which includes a quasi-crystalline photoresponsive polymer includes a polymer microcrystalline phase whose average diameter is in the range of 5 to 150 nm; accordingly, the medium has a high sensitivity.

<Optical Recording/Reproducing Device>

The term, “an optical recording/reproducing device” used in this specification refers to an optical recording device, an optical reproducing device, or an optical recording and reproducing device. Similarly, the term, “an optical recording/reproducing system” used in this specification refers to an optical recording system, an optical reproducing system, or an optical recording and reproducing system. In the following, an optical recording/reproducing device that records and/or reproduces information on the optical recording medium according to the invention explained above is described. The optical recording/reproducing device according to the invention can have a constitution adapted for a known recording/reproducing method such as the hologram recording and the light absorbance modulation recording, in accordance with the characteristics of the optical recording medium used in the recording/reproducing. Among these, the optical recording/reproducing device is preferably adapted for the hologram recording.

In this case, the recording/reproducing device preferably comprises the following two light sources: a signal light source that radiates signal light to the optical recording medium in accordance with information when the information is recorded on the optical recording medium; and a reference light source that radiates a reference light to the optical recording medium when the information recorded on the optical recording medium is reproduced (read). The device may further comprise a read sensor (for example, CCD) which makes use of a photoelectric conversion element and which senses the reproducing light and reads the information reproduced by the radiation of the reference light to the optical recording medium.

Further, some of the signal light source, the reference light source, and a read sensor can be omitted to make a read-only device or a write-only device in accordance with necessity.

In general, it is preferable for the device to further comprise other optical elements in accordance with necessity, so that, for example, a focusing optical system is provided which comprises a mirror, a beam splitter, a lens and the like and which help the optical recording medium be irradiated with the signal light, or a beam splitter is provided which takes out the signal light and the reference light out of the same light source.

There is no particular restriction on the signal light source and/or the reference light source. Usually, a known laser light source is preferably used such as a He—Ne Laser or an Ar Laser. The light source does not have to radiate a completely monochromatic beam such as a laser beam. A light source can be used if it emits beams having a narrow bright line spectrum whose half-value breadth is in the range of 2 to 3 nm. A very high-pressure mercury lamp is an example of such a light source. A white light source such as the sun and an electric lamp can also be used.

If the optical recording medium is a so-called disk-like medium such as a commercially-available DVD and CD-ROM, it is preferable for the device to comprise units which are adapted for such a disk medium and which are used in the DVD and CD-ROM technologies. Examples of the units include: a motor that holds and rotates the disk; and a unit that helps a predetermined place on the disk be irradiated with the signal light or the reference light (if the light source is a stationary type, a Glvano-Mirror can be used, or the light source can be mounted in a so-called head that can scan the light source in in-plane direction of the disk).

Examples of method of the hologram recording include hologram recording in which a plurality of holograms can be recorded in a single place by varying an angle between a normal line to a recording surface and incident object light; and hologram recording in which a plurality of holograms can be recorded in overlapping areas by changing a relative position of incident light to the recording surface.

In the following, an example of an optical recording/reproducing device according to the invention is described with reference to an optical system of a digital hologram memory described in SCIENCE, VOL. 265, p749 (1994) as an example.

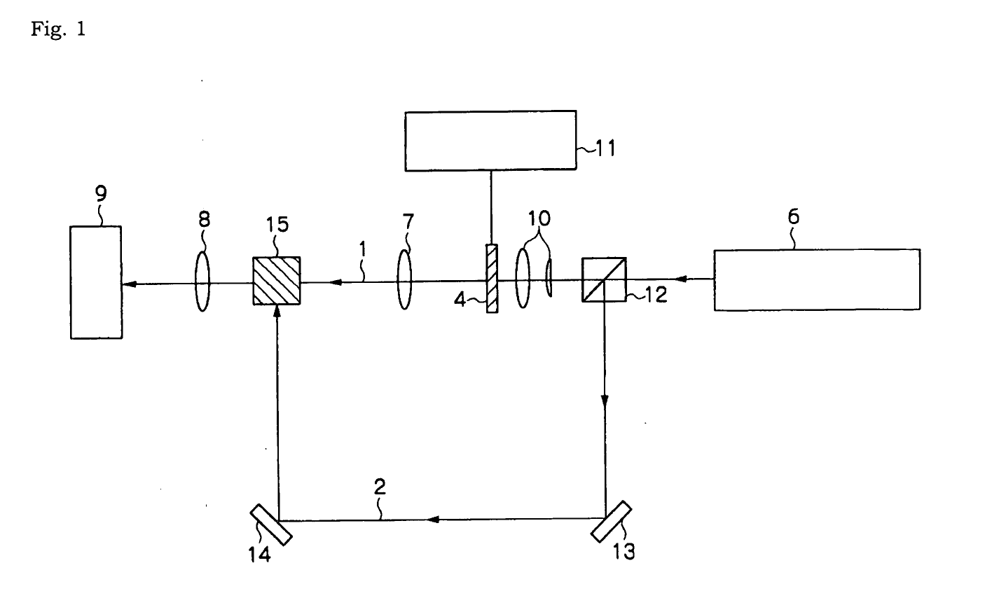

FIG. 1 is a schematic diagram showing an example of an optical recording/reproducing device according to the invention, and specifically shows an optical system of a digital hologram memory described in SCIENCE, VOL. 265, p749 (1994).

In the example, LiNbO₃ is used as an optical recording medium 15. The beams of light emitted from a light source 6 are divided into two groups of beams by means of a beam splitter 12. One of the groups which went through the beam splitter 12 is changed to broad parallel beams by a Collimator lens 10 and enters a spatial light modulator 4. The spatial light modulator 4 is controlled by a computer 11 and generates signal light 1 with two-dimensional intensity distributions. The signal light 1 is subjected to Fourier transformation by use of a Fourier transformation lens 7 and is concentrated on LiNbO₃. On the other hand, the group of beams reflected by the beam splitter 12 are reflected by mirrors 13 and 14, and enter LiNbO₃. These beams are a reference light 2. In this way, the hologram recording is conducted by allowing the signal light 1 and the reference light 2 to enter LiNbO₃ simultaneously. When the hologram is read, only the reference light 2 is allowed to enter LiNbO₃, and diffracted on a light path of the signal light 1 as if the signal light 1 went through LiNbO₃; the diffracted light is focused on a camera (a two-dimensional photo-receiving unit) 9 by a Fourier transformation lens 8.

In the digital hologram recording device such as the device shown in FIG. 1, a spatial light modulator is used for the input of data. Regarding the display of the bit data, for example, two pixels are used as a pair, and, for example a differential code method can be used in which “zero” is represented by shade and light, and “one” is represented by light and shade.

In the optical recording/reproducing device according to the invention, recording/reproducing of the hologram can be conducted with an optical recording medium according to the invention in place of LiNbO₃.

### EXAMPLES

In the following, the present invention is explained with reference to examples. However, the invention is by no means restricted to the examples.

(Evaluation Method and Evaluation Device)

Tg, Tm, Mw, Mn and a number molecular-weight distribution of the photoresponsive polymer used for producing optical recording media in examples and comparative examples mentioned below and an average diameter and an area ratio of a polymer microcrystalline phase formed in the recording layer are evaluated according to the above-described measurement methods.

Sensitivity is measured and evaluated according to a method described below as a changing ratio of birefringence to time.

-Optical Anisotropy (Birefringence) Recording by Polarized Light Irradiation-

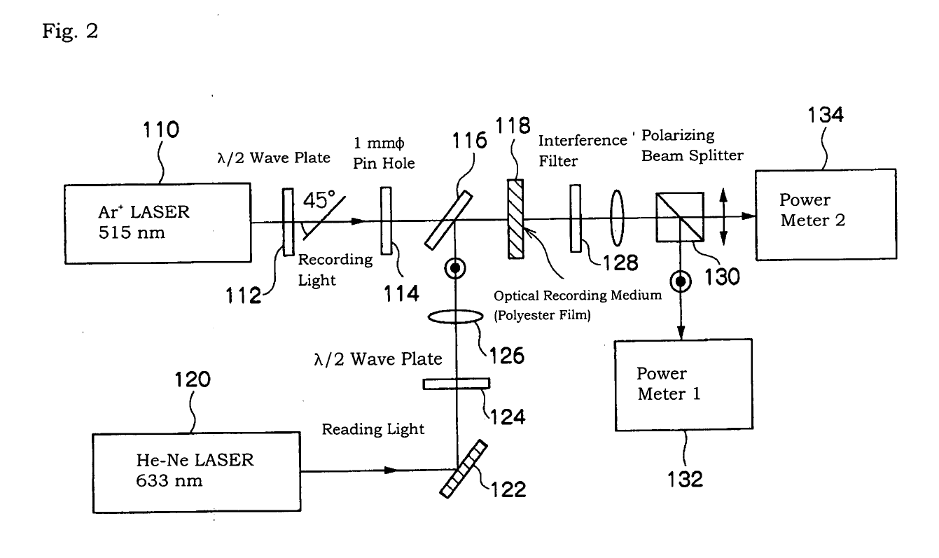

The sensitivities of the optical recording media used in examples are evaluated by conducting a birefringence recording with irradiation of linearly polarized light in an optical system shown in FIG. 2.

FIG. 2 is a schematic diagram showing an optical system employed for the evaluation of the optical recording medium. In FIG. 2, reference numeral 110 represents an argon ion laser (wavelength: 515 nm), 112 represents a half-wave plate, 114 represents a pin hole, 116 represents a half mirror, 118 represents an optical recording medium, 120 represents a helium-neon laser (wavelength: 633 nm), 122 represents a mirror, 124 represents a half-wave plate, 126 represents a lens, 128 represents an interference lens, 130 represents a polarized beam splitter, and 132 and 134 represent power meters.

Measurement of the optical recording medium 118 by the optical system shown in FIG. 2 is conducted in the following way. Firstly, beams of a linearly polarized light (7.9 mW) having a wavelength of 515 nm are emitted by the argon laser 110, go through the half-wave plate 112, the pin hole 114 and the half mirror 116, and enter the optical recording medium 118 as a recording light, wherein the photoresponsive polymer that constitutes a recording layer is sensitive to the light.

Beams of a linearly polarized light having a wavelength of 633 nm are emitted by the helium-neon laser 120, go through the mirror 122, the half-wave plate 124, the lens 126, and the half mirror 116, and enter the optical recording medium 118 as pump light at an angle of 45 degree relative to a polarization axis. The beams that went through the optical recording medium 118 go through the interference filter 128, are separated by the polarized beam splitter 130 into two groups of beams of polarized lights whose polarization directions are at right angles to each other. Light outputs of the respective polarized lights are measured by two power meters 132 and 134, respectively. The measured values obtained by the two power meters 132 and 134 are used to calculate the change in birefringence based on the polarization state of the transmitted light.

In the measurement of the change Δn in birefringence, exposure is carried out under the conditions of 2W/cm² 900 sec to conduct the birefringence recording, and a change (sensitivity) in birefringence in one minute from the start of the exposure is calculated.

### (Example 1)

-Recording Layer Materials-

When an optical recording medium according to example 1 is produced, a quasi-crystalline photoresponsive polymer that includes constitutional units represented by the formulae (1) to (4) with a constitutional ratio by mol of X:Y:R:S=0.9:0.1:0.3:0.7 is the only recording layer material. The physical properties of the quasi-crystalline photoresponsive polymer are: Tm=45° C.; Tg=31.9° C.; Mw/Mn=2.06; and Mn=18970.

-Production and Evaluation of Optical Recording Medium-

A flake-like quasi-crystalline photoresponsive polymer is placed on a cleansed glass substrate, and another glass substrate is placed on the polymer. By conducting hot pressing under reduced pressure, a sandwich-type glass cell medium is prepared with the quasi-crystalline photoresponsive polymer interposed between two glass substrates. The film thickness of the quasi-crystalline photoresponsive polymer layer is controlled at 250 μm during the hot pressing by disposing a spacer between the glass substrates. The polymer layer of the cell medium prepared in this way is a transparent flat film devoid of scattering and air bubbles.

In the next place, the obtained cell medium is heated to about 70° C. and the polymer sandwiched between the substrates is changed into a molten state, then cooled to about room temperature by a Peltier refrigerator at a temperature lowering rate of 30° C./min. In this way, an optical recording medium is obtained.

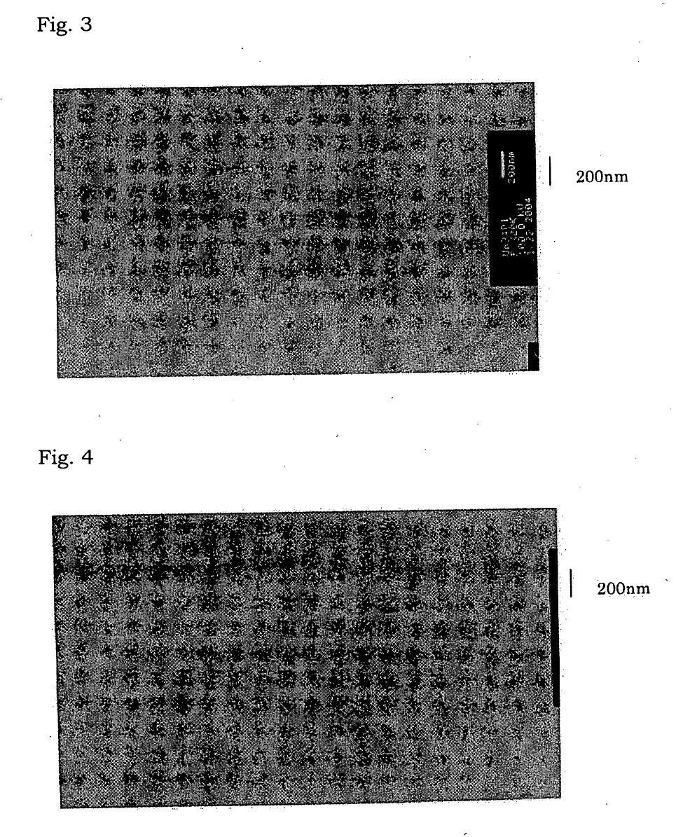

When the sensitivity of the optical recording medium is measured according to the method mentioned above, it is 0.00019, wherein preferable sensitivity from the practical point of view is 0.00014 or higher. When the recording layer of the optical recording medium is observed with a TEM and the obtained TEM image is subjected to the image analysis, it is found that a microcrystalline phase having an average diameter of 25 nm is formed and an area proportion thereof is 0.43%. For reference, a TEM image (photo before the image analysis) obtained when the recording layer of the optical recording medium is observed with a TEM is shown in FIG. 3. The length of the white bar line extending in a vertical direction shown in the upper right in FIG. 3 represents 200 nm.

### Example 2

-Recording Layer Materials-

When an optical recording medium according to example 2 is produced, a quasi-crystalline photosensitive polymer including constitutional units represented by the constitutional formulae (1), (3) and (4) with the constitutive ratio by mol of X:R:S=1:0.3:0.7 is the only recording layer material. The physical properties of the polymer are: Tm=54° C.; Tg=35° C.; Mw/Mn=2.15; and Mn=20566.

Production and Evaluation of Optical Recording Medium

A flake-like quasi-crystalline photoresponsive polymer is placed on a cleansed glass substrate, and another glass substrate is placed on the polymer. By conducting hot pressing under reduced pressure, a sandwich-type glass cell medium is prepared with the quasi-crystalline photoresponsive polymer interposed between two glass substrates. The film thickness of the quasi-crystalline photoresponsive polymer layer is controlled at 250 μm during the hot pressing by disposing a spacer between the glass substrates. The polymer layer of the cell medium prepared in this way is a transparent flat film devoid of scattering and air bubbles.

In the next place, the obtained cell medium is heated to about 70° C. and the polymer sandwiched between the substrates is changed into a molten state, then cooled to about room temperature by a Peltier refrigerator at a temperature lowering rate of 30° C./min. In this way, an optical recording medium is obtained.

When the sensitivity of the optical recording medium is measured according to the method mentioned above, it is 0.00014, wherein preferable sensitivity from the practical point of view is 0.00014 or higher. When the recording layer of the optical recording medium is observed with a TEM and the obtained TEM image is subjected to the image analysis, it is found that a microcrystalline phase having an average diameter of 70 nm is formed and an area proportion thereof is 3.12%. In the microcrystalline phase, there are microcrystals having a size of about 200 nm. For reference, a TEM image (photo before the image analysis) obtained when the recording layer of the optical recording medium is observed with a TEM is shown in FIG. 4. The length of the white bar line extending in a vertical direction shown in the upper right in FIG. 3 represents 200 nm.

As is described above, according to the present invention, an optical recording medium with a high sensitivity, a manufacturing method thereof, and an optical recording device using the same can be provided.

1. An optical recording medium comprising an optically-active recording layer, wherein the recording layer includes a polymer microcrystalline phase.

2. An optical recording medium according to claim 1, wherein an average diameter of the polymer microcrystalline phase is in a range of 5 to 150 nm.

3. An optical recording medium according to claim 1, wherein an average diameter of the polymer microcrystalline phase is in the range of 5 to 70 nm.

4. An optical recording medium according to claim 1, wherein an area proportion of the polymer microcrystalline phase in the recording layer is 0.1% or higher.

5. An optical recording medium according to claim 1, wherein the recording layer includes a photoresponsive polymer.

6. An optical recording medium according to claim 1, wherein the recording layer includes a non-photoresponsive polymer.

7. An optical recording medium according to claim 5, wherein the polymer microcrystalline phase includes the photoresponsive polymer.

8. An optical recording medium according to claim 6, wherein the polymer microcrystalline phase includes the non-photoresponsive polymer.

9. An optical recording medium according to claim 5, wherein the photoresponsive polymer has a melting point Tm, a glass transition point Tg, and a ratio of a weight average molecular weight Mw to a number average molecular weight Mn (Mw/Mn) of 1.05 or higher.

10. An optical recording medium according to claim 9, wherein the number average molecular weight Mn is in a range of 5,000 to 100,000.

11. An optical recording medium according to claim 9, wherein difference between the melting point Tm and the glass transition point Tg is 60° C. or smaller.

12. An optical recording medium according to claim 9, wherein the glass transition point Tg is 35° C. or higher.

13. An optical recording medium according to claim 9, wherein a number molecular-weight distribution has two or more maxima.

14. An optical recording medium according to claim 13, wherein a largest difference between molecular weights at any two of the maxima is 5000 or larger.

15. An optical recording medium according to claim 5, wherein the photoresponsive polymer has an azo group.

16. An optical recording medium according to claim 5, wherein a content of the photoresponsive polymer in the recording layer is in a range of 1.0 to 100 weight %.

17. An optical recording medium according to claim 1, wherein the optical recording medium comprises a substrate and the recording layer is provided on the substrate.

18. An optical recording medium according to claim 17, wherein a reflective layer is provided between the substrate and the recording layer.

19. A method of producing an optical recording medium comprising an optically-active recording layer made of recording layer materials including a polymer having a melting point Tm and a glass transition point Tg, the method comprising:
heating the recording layer materials to the melting point Tm or higher; and
cooling the recording layer materials at a cooling rate of 2° C./min or higher to form the recording layer,
wherein a recording layer after the cooling comprises a polymer microcrystalline phase having an average diameter in a range of 5 to 150 nm.

20. An optical recording/reproducing device that records and/or reproduces information by using an optical recording medium including an optically-active recording layer,
wherein the recording layer comprises a polymer microcrystalline phase having an average diameter in a range of 5 to 150 nm.
